(19) United States
(12) Patent Application Publication
(10) Pub. No.: US 2007/0195959 A1
(43) Pub. Date: Aug. 23, 2007

(54) Synchronizing encrypted data without content decryption

(75) Inventor: Simon Peter Clarke, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/358,506

(22) Filed: Feb. 21, 2006

(51) Int. Cl. H04L 9/00

(52) U.S. Cl. 380/278

(57) ABSTRACT

Encrypted content is synchronized without requiring a password. The structure of the data is synchronized while the content of the data remains encrypted. When the user desires viewing the encrypted content of the structure, the user is prompted for the password to render the encrypted content. Succinctly stated, the password requirement is pushed from the time of synchronization to the time of rendering of the content. In this manner, a user may synchronize a device without needing to enter a password. Such keyless synchronization promotes efficiency, increases productivity and pushes the password prompt to a more optimal time for the user.

### BACKGROUND

Users of applications in a distributed environment need to keep data located on a local device synchronized with data located on a server. Many times during a synchronization process, the data that requires synchronization is encrypted data. During the synchronization process of the encrypted data, the user is prompted for a password for the data that is encrypted. Such prompting slows down the synchronization process, reduces productivity, and facilitates inefficiencies.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

Encrypted content is synchronized without requiring a password. The structure of the data is synchronized, while the content of the data remains encrypted. When the user desires viewing the content of the structure, the user is prompted for the password to the encrypted content. Succinctly stated, the password requirement is pushed from the time of synchronization to the time of rendering of the content of the data. In this manner, a user may synchronize data without needing a password. Such keyless synchronization promotes efficiency, increases productivity and pushes the password prompt to a more optimal time for the user.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing device;

FIG. 2 represents one exemplary environment for synchronizing encrypted data without content decryption;

FIG. 3 represents one exemplary system overview for encrypting and serializing data;

FIG. 4 represents an encryption and serialization process;

FIG. 5 represents an encryption and serialization process for data that has been modified;

FIG. 6 represents an operational flow diagram for serialization and encryption; and

FIG. 7 represents an operational flow diagram for synchronizing encrypted data without content decryption.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, steps or modules.

Users of applications in a distributed environment need to keep data located on a local device synchronized with data located on a remote device such as a server. For example, a plurality of users may have access to data located on a mutual file server. Each individual may also have a local copy of this data on a local device to allow drafting, editing and offline access. Therefore, the most up-to-date version of the data should be maintained on the server. Such updating is especially important when several users are synchronizing updates to the data on the server.

Synchronization with the server may occur in a number of ways. For example, synchronization may occur continuously, at preset intervals, and when a change has occurred. With a mobile device, synchronization may occur when the user connects the mobile device to the network associated with the server. One can imagine a busy executive returning from a trip, running to the office, plugging a laptop into a network to synchronize data that was edited on a plane, and then unplugging the laptop to run to another meeting. In such a situation, time and efficiency of synchronization is a very real asset. Accordingly, when synchronization is cumbersome and time consuming, business efficiency is reduced, time is wasted, and revenues are lost.

Many times during a synchronization process, a password is required to merge encrypted data. Generally, encrypted data requires a password for access. If the password were required during synchronization, a user would be required to input the password in order to synchronize the data. One can imagine the extreme inefficiency that may ensue. The busy executive may have twenty encrypted files that were edited on the plane flight. During synchronization the busy executive may be required to enter twenty different passwords to synchronize the encrypted files. Such a requirement slows down the synchronization process, reduces productivity and facilitates inefficiencies.

As such, encrypted data may be synchronized without passwords. The structure of the data is synchronized while the content of the data remains encrypted. When the user desires viewing the content of the structure, the user is then prompted for the password to the encrypted content. Succinctly stated, the password requirement is pushed from synchronization to the time of rendering of the content of the data. In this manner, a user may synchronize a device without needing a password. Such keyless synchronization promotes efficiency, increases productivity and pushes the password prompt to a more optimal time for the user.

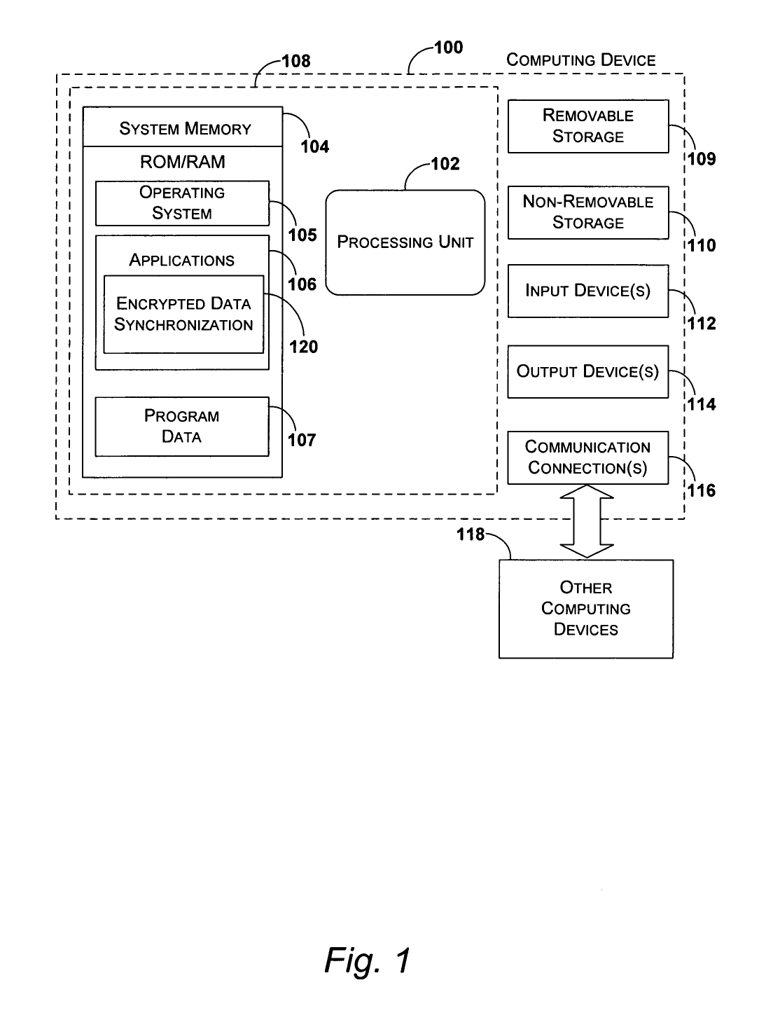

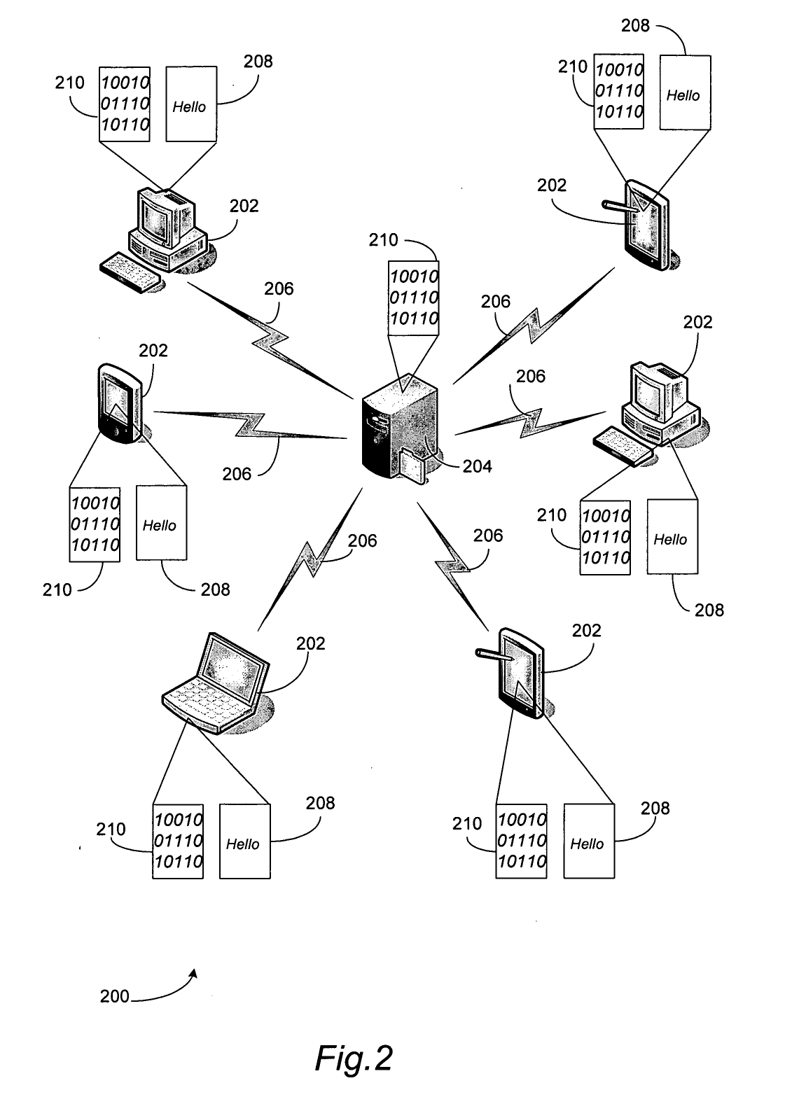

FIG. 2 represents one exemplary environment for synchronizing encrypted data without content decryption. System 200 represents a modular overview of a computing environment. System 200 may include computing device 202. Computing device 202 may include a desktop computing device, mobile computing device, a laptop, a personal digital assistant, a notebook computer, and/or any other type of computing device functional to store data. In one aspect, computing device 202 includes computing device 100 as exemplified in FIG. 1.

System 200 also includes server 204. Server 204 includes any type of server functional to store data in a distributed environment. For example, server 204 may include a windows server, a document authoring and versioning server, a file transfer protocol server, and/or an exchange server. Server 204 is in communication with computing device 202 via network connection 206. Network connection 206 may include a hardwired network connection and/or a wireless network connection. Network connection 206 may include any type of network connection functional to transmit data between a computing device and a server.

In the distributed environment, computing device 202 may have application file 208 associated therewith. Application file 208 may be associated with any application for processing data. In one embodiment, the application is a MICROSOFT ONENOTE application of MICROSOFT CORPORATION headquartered in Redmond, Wash. Application file 208 may be associated with serialized data structure 210 as is more fully set forth below. Serialized data structure 210 facilitates the storage of data and the synchronization of data between computing device 202 and server 204.

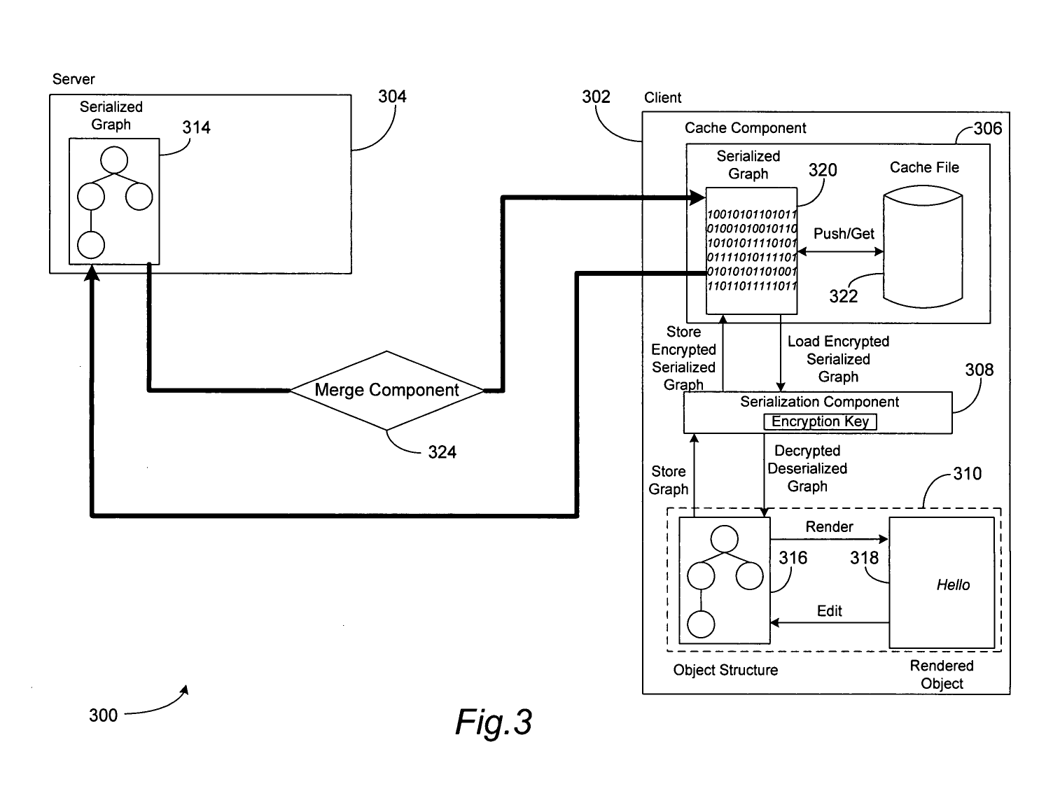

FIG. 3 represents one exemplary system overview for encrypting and serializing data. System 300 represents a modular overview of client 302 and server 304. System 300 may be integrated as a combination of software and hardware elements, an operating system or any combination thereof. Hardware, databases, software, applications, and/or programs referenced herein may be integrated as a single element or include various elements in communication with one another. Software and/or hardware elements are depicted herein for explanatory purposes only and not for limiting the configuration to multiple elements or a single element performing several functions unless specifically specified herein. For example, as depicted in FIG. 3, system 300 includes client 302 having cache component 306, serialization component 308 and application component 310. Reference numbers 306-310 may include separate programs, separate databases and separate hardware. Reference numbers 306-310 may also include a single program or any combination of single and multiple programs. Similarly, system 300 includes server 304 having serialized graph 314. Reference numbers 312-314 may include separate programs, separate databases and separate hardware. Reference numbers 312-314 may also include a single program or any combination of single and multiple programs.

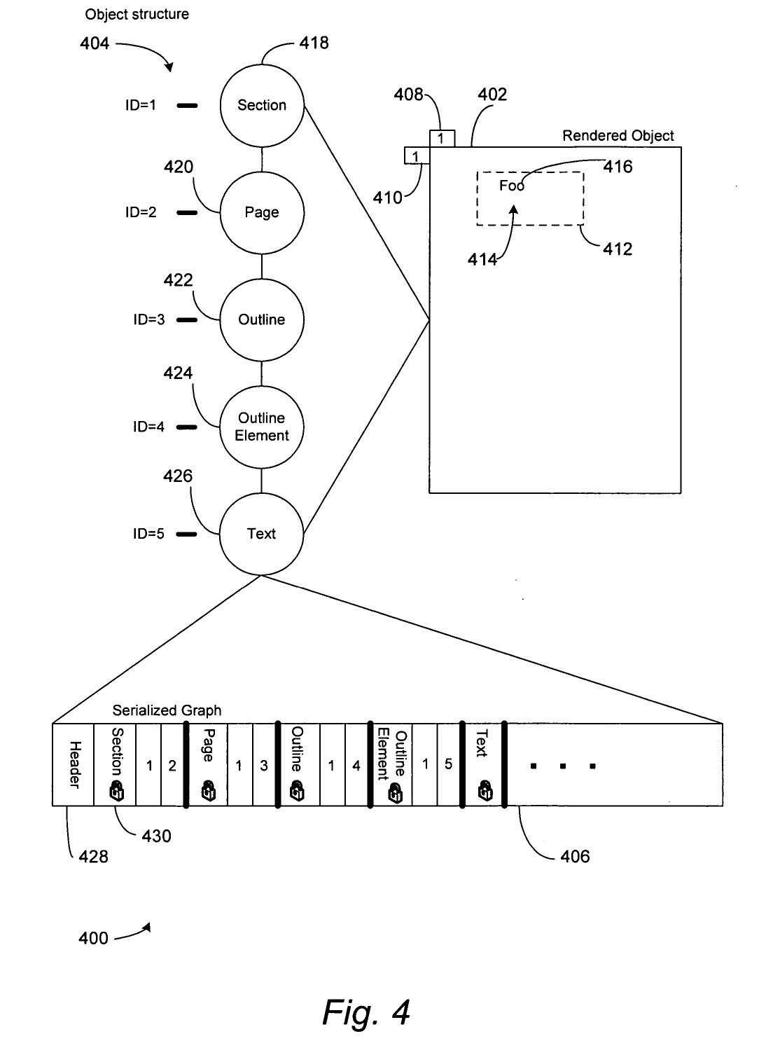

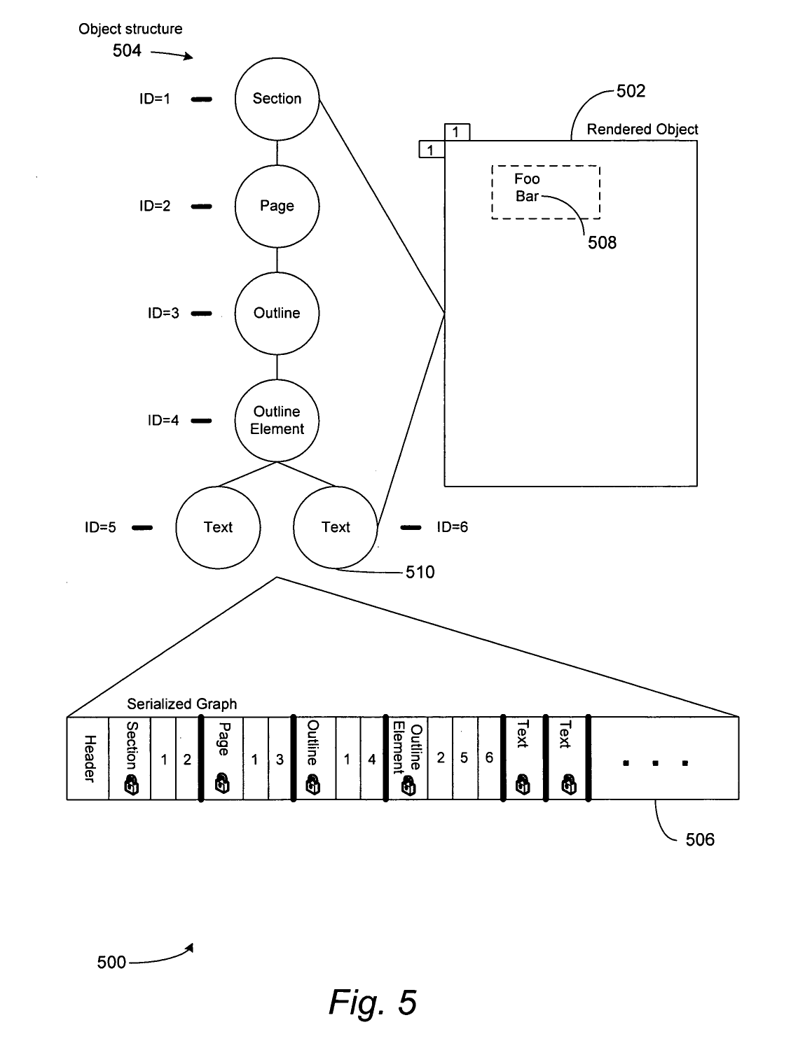

Application component 310 includes rendered object 318 and object structure 316. Object structure 316 is more fully addressed below in association with FIGS. 4 and 5. Rendered object 318 may include any rendered object for an application. For example, rendered object 318 may be a notes document associated with a note application. As another example, rendered object 318 may be a word processing document associated with a word processing application. Rendered object 318 is associated with object structure 316. Object structure 316 is a structure for facilitating storage of a document. In one embodiment, object structure 316 is a tree structure of the document that includes connected nodes for describing the structure and content of the file. When a request is made to render the file, application component 310 calls on object structure 316 to facilitate the rendering of the object. Conversely, when the object is rendered and a user decides to edit the object, changes to rendered object 318 are associated with object structure 316.

Serialization component 308 is a component for facilitating the serialization/deserialization and encryption/decryption (optional) of object structure 316 so that object structure 316 maybe stored in/loaded from cache component 306. The serialization and encryption of object structure 316 is more fully addressed below in association with FIGS. 4 and 5. When storage is desired, application component 310 may associate object structure 316 with serialization component 308, where object structure 316 is serialized and encrypted. The serialized and encrypted object structure may then be stored in cache component 306. When loading is desired, application component 310 may request to load the encrypted serialized graph. Serialization component 308 may deserialize and decrypt the graph to produce object structure 316. Object structure 316 may then be rendered.

Cache component 306 includes serialized graph 320 and cache file 322. Bits are pushed and retrieved between serialized graph 320 and cache file 322 during processing of the file. Server 304 includes serialized graph 314. Serialized graph 314 may be a serialized “Master” graph of the file. During synchronization, serialized graph 314 and serialized graph 320 attempt to reconcile as shown by the arrows.

During a synchronization process, changes associated with serialized graph 314 are updated to serialized graph 320 associated with client 302. In one aspect, merge component 324 may be associated with the synchronization process. As is more fully set forth below, merge component 324 provides synchronization to minimize any true conflicts between the two devices. By reducing the true conflicts, server 304 and client 302 may seamlessly synchronize and a decryption of the data content is not required for synchronization.

FIG. 4 represents an encryption and serialization process. Aspects of FIG. 4 represent elements for facilitating synchronizing encrypted data without content decryption. System 400 includes rendered object 402, object structure 404 and serialized graph 406. In this example, rendered object 402 is an ONENOTE document. Rendered object 402 includes section 408, page 410, outline 412, outline element 414, and text 416. Section 408 includes a section within the file. Page 410 includes the pages within section 408. Outline 412 includes a portion of the page that is identified as a grouping. Outline element 414 is an element associated with outline 412 and text 416 is the text associated with outline element 414. These categories are described herein for exemplary purposes, other categories of rendered object 402 may be implemented to describe the object. For example, rendered object 402 may include a paragraph element, sentence element, graphic element, chart element, etc.

Object structure 404 is the object structure of rendered object 402. Object structure 404 includes section node 418, page node 420, outline node 422, outline element node 424 and text node 426. Each of the nodes is connected to another node as indicated in FIG. 4. For example, page node 420 is a child of section node 418. Each node includes the content data of the element. For example, page node 420 may include the content data that indicates the dimensions of the page, the color of the page, borders associated with the page, etc. Likewise, text node 426 may include the content data that indicates the identity of the text, font, size, color etc. During a serialization process, nodes 418-426 may be assigned an identifier such as an integer. In this manner, the structure of the nodes may be associated to one another.

Serialized graph 406 includes several elements for facilitating synchronizing encrypted files without content decryption. Serialized graph 406 depicts a serialized representation of object structure 404. Serialized graph 406 includes header 428. Header 428 may include data that indicates that the data following is encrypted. The serialized graph is encrypted by a cipher. The cipher encrypts a group of data. As indicated by serialized graph 406, the cipher is applied to bits of the serialization that include the content of the node. For example, section bits 430 include the content of the section node 418. These bits are encrypted with the cipher. However, the bits following may not be encrypted. Also, bits indicating the node type are not encrypted. As shown, following section bits 430 is a set of bits indicating the number of children nodes following section node 418. Here, the number of children nodes equals 1. Following the aforementioned bits is a section of bits indicating the ID of the node that is the child of section node 418. The ID of the child node is two. In a like manner, each of the nodes of object structure 404 are serialized and encrypted. As indicated, the bits that indicate the content of the node are encrypted while the structure of the object is not encrypted. Accordingly, when synchronization occurs, the structure may be synchronized without requiring the password. The password is required when the user wants to view the content of the structure.

FIG. 5 represents an encryption and serialization process for data that has been modified. FIG. 5 is similar to FIG. 4, except a modification has been made to the data. System 500 includes rendered object 502, object structure 504 and serialized graph 506. Render object 502 includes added text 508. In object structure 504, added text 508 is represented as added text node 510. In this example, added text node 510 has an ID that is equal to six. Object structure 504 is similar to object structure 404 except the outline element includes a second child (i.e. added text node 510). Serialized graph 506 includes outline element bits, which include content data of the outline element. Following the bits of the outline element are bits indicating that the outline element node is followed by two nodes. The IDs for the two nodes are five and six, respectively. Following the aforementioned bits are bits, which include the content data of the two text nodes.

The make-up for serialized graph 506 is represented as such in light of the following example in reference to FIGS. 4 and 5. In this example, FIG. 4 represents data that was generated on a first client and then synchronized to a server. The content of the object structure is encrypted and, according to the cipher encryption, the structure of the object structure is not encrypted. A second client decides to synchronize with the remote device to obtain the data. The second client synchronizes without being prompted for the password. At this point, the second client has the structure of the data but the content of the data is still encrypted. The second client then decides to view the file. The second client is prompted for the password and when the password is entered the content of the data is decrypted.

Returning to FIG. 5, client two has the decrypted data on the computing device. Client one then makes a change to the data and adds more text as indicated by added text node 510. Client one synchronizes with the server to update the server with the added element. Client two then synchronizes with the server. At this point, client two has the original file on the computing device (e.g. FIG. 4). The original file is synchronized with the server and the structure of the modified file is updated to the second client. Client two is not required to enter a password at this point because the structure of the data is accessible to client two. When client two desires viewing the content of the file, client two is prompted for the password because the content is encrypted. This example is illustrative of many types of synchronization activities. For example, the synchronization process may include several changes, a conflict resolution process, merging, true conflicts, etc.

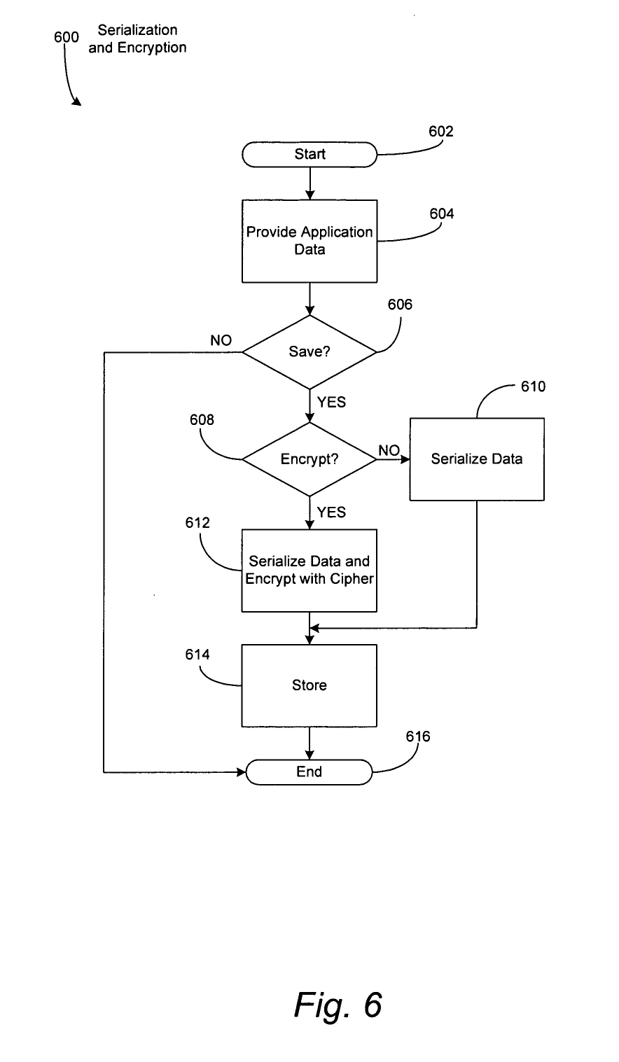

FIG. 6 represents an operational flow diagram for serialization and encryption. Operational flow 600 begins at start operation 602 and continues to operation 604, where application data is provided. For example, a user may generate a note file, word processing file, etc. Operational flow 600 continues to decision operation 606. At decision operation 606, it is decided whether to save the data. A user may decide not to save the data. For example, the user may not prefer the draft of the document etc. In such a situation, operational flow 600 continues to end operation 616. When a save operation is instantiated, operational flow 600 continues to decision operation 608. At decision operation 608, it is decided whether to encrypt the data. When it is decided not to encrypt the data, operational flow 600 continues to operation 610 where the data is serialized. The data may be serialized as described above in association with FIGS. 4 and 5. Operational flow 600 then continues to operation 614 as indicated.

When it is decided to encrypt the data, operational flow 600 flows from decision operation 608 to operation 612. At operation 612, the data is serialized and encrypted with a cipher. The data may be serialized as described above in association with FIGS. 4 and 5. The data is encrypted with a cipher. The cipher is applied to bits of the serialization that include the content of the node. However, the bits of the data that describe the structure of the data are not encrypted with the cipher. In this manner, the content of the data is encrypted and the structure of the data is not encrypted. At operation 614 the data is stored. The data may be stored in a cache or any other manner for storing data. Operational flow 600 continues to end operation 616.

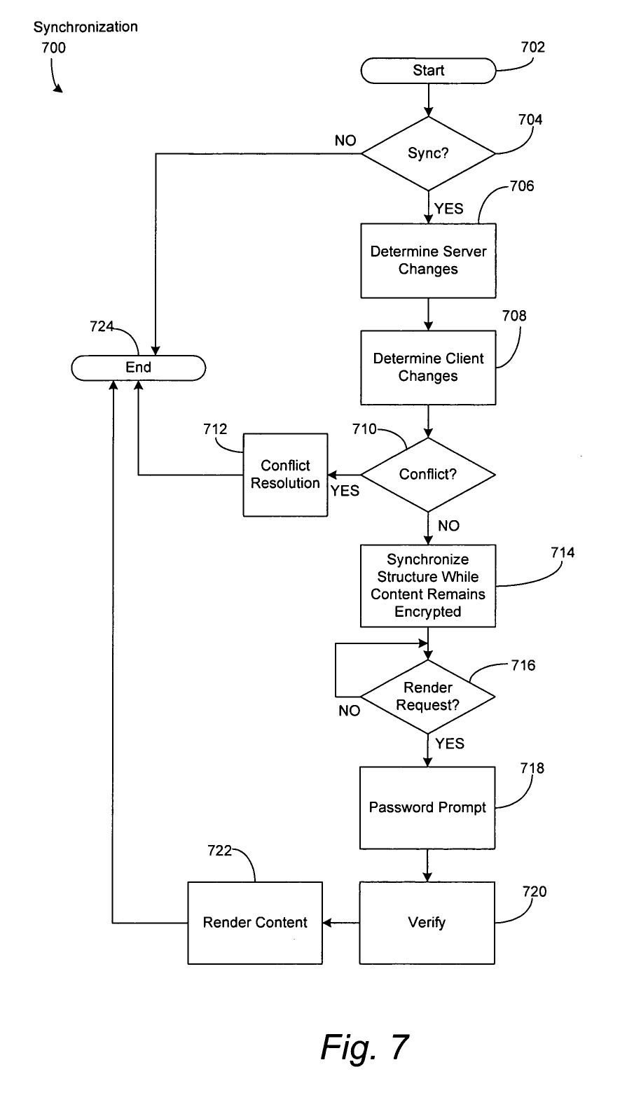

FIG. 7 represents an operational flow diagram for synchronizing encrypted data without content decryption. Operational flow 700 begins at start operation 702 and continues to decision operation 704. At decision operation 704, it is decided whether to sync the client data and the server data (e.g. remote file). When synchronization is not instantiated, operational flow 700 continues to end operation 724. When synchronization is instantiated, operational flow 700 continues to operation 706 where server changes are determined. Server changes are changes to the data that is saved to the server. Operational flow 700 then continues to operation 708 where client changes are determined. Client changes are changes made on a client-computing device that have not been synchronized with the server.

Operational flow 700 continues to decision operation 710 where it is determined whether a conflict exists in view of the determined changes. If a conflict does exist, operational flow 700 continues to operation 712 for conflict resolution. A conflict and conflict resolution may occur in any number of operations and combinations. For example, the operation may determine that there are no changes on either the server or the client. In such a situation, the conflict resolution is to not synchronize. As another example, changes may occur to both the client and the server. These changes may also apply to the same identified structure on both the client and the server. For example, the server may have a change that modifies the word “apple” to “orange”, and the client may have a change that modifies the word “apple” to “banana.” In such a situation, a “true” conflict exists because the structure of the data is in conflict (i.e. same node content changed). Therefore, conflict resolution may include saving two versions of a file during the synchronization process. In one aspect, a conflict resolution process may be configured to minimize the occurrences of true conflicts. There are many combinations of conflict resolution procedures that may be utilized and the disclosure is not limited to the ones set forth herein.

When a conflict does not exist, operational flow 700 continues to operation 714. There are many occurrences where a conflict will not exist. A conflict may not exist when there is a change on the server and no changes on the client. A conflict may not exist when there is a change on the client and no changes on the server. A conflict may not exist when the structure of the file is not in conflict. For example the server may have a change on page one of a document and the client may have a change on page two of the document. In such a situation, the structure of the data is not in conflict.

At operation 714, the structure of the data is synchronized while the content remains encrypted. As explained above in association with FIGS. 4 and 5, the content of the nodes are encrypted with a cipher, yet, data identifying the structure is not encrypted. At this point in operational flow 700, the structure of the data is synchronized.

At decision operation 716, a render request may be received. For example, a user may decide to view the synchronized file. If such a request is received, operational flow 700 continues to operation 718 where the password prompt is generated. If a render request is not received, operational flow 700 loops back upward. In another embodiment, when a render request is not received, operational flow 700 may continue to end operation 724 (not shown). At operation 720, the password is verified and at operation 722 the content of the data is rendered. Stated another way, the content of the nodes that are encrypted by the cipher are decrypted so that the user may have access to the content of the nodes. Operational flow 700 continues to end operation 724.

As is evident from the above disclosure, encrypted data may be synchronized without a password. The structure of the data is synchronized while the content of the data remains encrypted. When the user desires viewing the content of the structure, the user is then prompted for the password to the encrypted content. Such keyless synchronization promotes efficiency, increases productivity and pushes the password prompt to a more optimal time for the user.

Referring to FIG. 1, an exemplary system for implementing the invention includes a computing device, such as computing device 100. In a basic configuration, computing device 100 may include any type of stationary computing device or a mobile computing device. Computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120 for encrypted data synchronization. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included.

Computing device 100 also contains communication connection(s) 116 that allow the device to communicate with other computing devices 118, such as over a network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for synchronizing encrypted data without content decryption, the method comprising:
instantiating a synchronization operation between remote data and local data;
accessing the remote data, wherein the remote data includes encrypted content data and unencrypted structure data;
merging the unencrypted data structure of the remote data with a data structure of the local data; and
maintaining the encrypted content data during synchronization.

2. The computer-implemented method of claim 1, wherein the encrypted content data is encrypted by a cipher.

3. The computer-implemented method of claim 1, wherein the unencrypted structure data includes node type data.

4. The computer-implemented method of claim 1, wherein the unencrypted structure data includes number of children nodes.

5. The computer-implemented method of claim 4, wherein the unencrypted structure data includes an ID of the children nodes.

6. The computer-implemented method of claim 1, wherein synchronizing the remote data with local data includes performing a conflict resolution procedure.

7. The computer-implemented method of claim 1, further comprising generating a password prompt when a request to render the synchronized data is received.

8. The computer-implemented method of claim 1, wherein synchronizing the remote data with the local data includes synchronizing without a password.

9. A computer-readable medium having computer-executable instructions for synchronizing encrypted files without content decryption, the instructions comprising:
instantiating a synchronization operation;
accessing a first serialized file, wherein the first serialized file includes:
an encrypted field, wherein the encrypted field includes content data associated with a node of an object structure; and
an unencrypted field, wherein the unencrypted field includes structure data associated with the structure of the object structure;
merging the unencrypted field with the second serialized file; and
maintaining the encryption of the encrypted field during synchronization.

10. The computer-readable medium of claim 9, wherein the encrypted field includes cipher encryption.

11. The computer-readable medium of claim 9, wherein the structure data includes node type data.

12. The computer-readable medium of claim 9, wherein the structure data includes the number of children nodes associated with the node.

13. The computer-readable medium of claim 12, wherein the structure data includes the ID of children nodes associated with the node.

14. The computer-readable medium of claim 9, further comprising generating a password prompt when a request to render the synchronized file is received.

15. The computer-readable medium of claim 9, wherein a password is not required during synchronization.

16. A computer-readable medium having a data structure for synchronizing encrypted files without content decryption, the data structure comprising:
an encrypted field, wherein the encrypted field includes content data associated with a node of an object structure, wherein the encrypted field is configured to maintain an encryption during synchronization; and
an unencrypted field, wherein the unencrypted field includes structure data associated with the structure of the object structure, wherein the unencrypted field is configured to merge with a second data structure during synchronization.

17. The computer-readable medium of claim 16, wherein the structure data includes node type data.

18. The computer-readable medium of claim 16, wherein the structure data includes a number of children nodes associated with the node.

19. The computer-readable medium of claim 18, wherein the structure data includes a ID of children nodes associated with the node.

20. The computer-readable medium of claim 16, wherein the encrypted field includes a cipher.
